(19) United States
(12) Patent Application Publication
(10) Pub. No.: US 2009/0010643 A1
(43) Pub. Date: Jan. 8, 2009

(54) Method and apparatus for identifying faults in a passive optical network

(76) Inventors: David A. DeLew, Rohnert Park, CA (US); Vinita Gupta, Novato, CA (US); Bernardus F. Egberts, Petaluma, CA (US); Daniel L. Smith, Petaluma, CA (US); Paul A. Henderson, Rohnert Park, CA (US); Edward J. Sackman, Santa Rosa, CA (US); Michael J. Wurst, Santa Rosa, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/825,650

(22) Filed: Jul. 6, 2007

(51) Int. Cl. H04B 10/08

(52) U.S. Cl. 398/17

(57) ABSTRACT

Component malfunctions in passive optical networks (PON) can increase bit error rates and decrease signal-to-noise ratio in communications signals. These faults may cause the receivers of the signals, either the optical line terminal (OLT) or optical network terminals (ONTs), to experience intermittent faults and/or may result in misinterpreted commands that disrupt other ONT's communication, resulting in a rogue ONT condition. Existing PON protocol detection methods may not detect these types of malfunctions. An embodiment of the present invention identifies faults in a PON by transmitting a test series of data patterns via an optical communications path from a first network node to a second network node. The test series is compared to an expected series of data patterns. An error rate may be calculated as a function of the differences between the test series and expected series. The error rate may be reported to identify faults in the PON.

### BACKGROUND OF THE INVENTION

In a passive optical network (PON), multiple optical network terminals (ONTs) or optical network units (ONUs) transmit data to an optical line terminal (OLT) using a common optical wavelength and fiber optic media. Various components of the optical distribution network (ODN), including the OLT, optical components, and ONT(s), can malfunction in such a way that upstream and/or downstream communications signals have too low a signal-to-noise ratio (SNR). This can make it difficult for the receiver of that signal, either the ONT or OLT, to communicate consistently and may result in misinterpreted commands that disrupt other ONT's communications, resulting in a rogue ONT condition.

Existing error detection techniques, such as those described in the various PON protocols, may not detect SNR types of faults or if detected (e.g., by system failure), they may not be identified as faults due to low SNR. For example, in certain situations, a faulty ONT may not exceed the International Telecommunications Union (ITU) G.983.1 BIP-8 detection threshold levels when the faults are due to a bursty error sequence that has multiple bit errors. Thus, these faults may not be detected by either the BIP-8 or the CRC-8 values within the Physical Layer Operations, Administration and Maintenance (PLOAM) message fields. These bursty, intermittent types of errors may not occur long enough to generate the G.983.1 standard SDi, LCD, OAML or FRML type error conditions. However, these faulty communications can lead to incorrect OLT to ONT map communications and result in collision between upstream data communications.

Two ONT malfunctions not currently detected using existing standards, such as G.943.1, may include the following. First, is an occurrence of an OLT receiving too low a SNR on the upstream signal from the ONT. This can occur for a variety of reasons, including but not limited to: too low a jitter tolerance on the OLT's clock recovery device; too high a jitter output on the ONT's transmitting device; too low a power level output from the ONT's laser; too low a SNR of the signal from the ONT due to defects in the ODN, such as kinked fiber, too long a fiber, and dirty fiber terminations.

Second, is an occurrence of an ONT receiving too low a SNR on the downstream signal from the OLT. This can occur for a variety of reasons, including, but not limited to: too low a jitter tolerance on the ONT's clock recovery device; too high a jitter output on the OLT's transmitting device; too low a power level output from the OLT's laser; too low a SNR of the signal from the ONT due to defects in the ODN, such as a kinked fiber; too long a fiber; and dirty fiber terminations.

### SUMMARY OF THE INVENTION

A method and apparatus of identifying a fault in a passive optical network (PON) according to an example embodiment of the invention may include transmitting a test series of at least one data pattern via an optical communications path from a first network node to a second network node in a passive optical network. The example method may include comparing the test series to an expected series of at least one data pattern expected to be observed in the test series transmitted via the optical communications path, and calculating an error rate as a function of differences between the test series and expected series. The example embodiment may further include reporting the error rate to identify a fault in the passive optical network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example passive optical network (PON);

FIG. 2 is a network diagram of an example portion of a PON in which optical elements are configured to identify faults in a PON in accordance with one embodiment of the present invention;

FIG. 3 is a network diagram of an example portion of a PON in which an Optical Line Terminal (OLT) and an Optical Network Unit (ONU) or Optical Network Terminal (ONT) are configured to identify faults in the PON in accordance with one embodiment of the present invention;

FIG. 4 is a network diagram of an example portion of a PON in which an external node is configured to identify faults in the PON in accordance with one embodiment of the present invention;

FIG. 5 is a flow diagram performed in accordance with an example embodiment of the invention;

FIG. 6 is a flow diagram performed in accordance with an example embodiment of the invention; and

FIG. 7 is a flow diagram performed in accordance with an example embodiment of the invention.

### DETAILED DESCRIPTION OF THE INVENTION

A description of example embodiments of the invention follows.

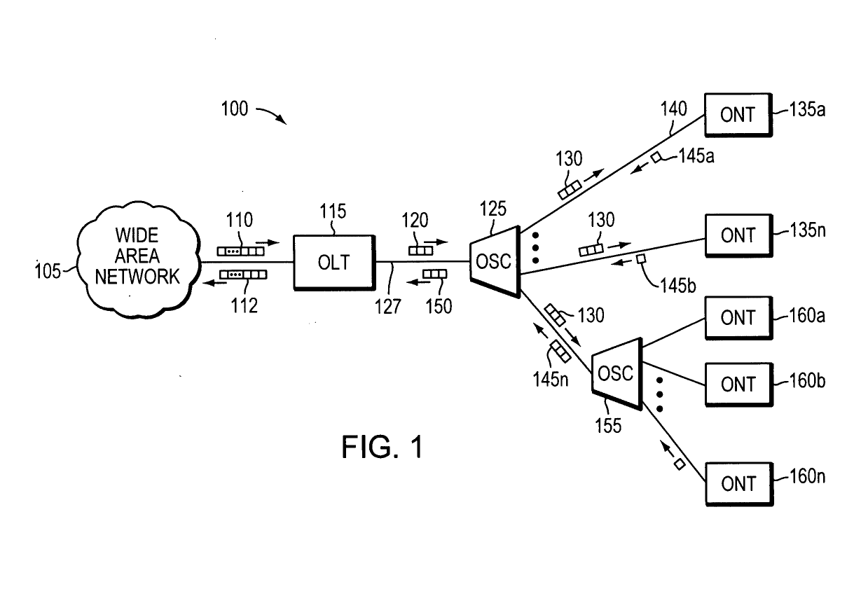

FIG. 1 is a network diagram of a passive optical network (PON) 100 illustrating aspects of an example embodiment of the invention. The PON 100 includes an optical line terminal (OLT) 115, an optical splitter/combiner (OSC) 125, and at least one optical network unit (ONT) 135a-n, 160a-n. In other network embodiments, optical network units (ONUs) (not shown) may be in optical communication with multiple ONT(s) 135a-n, 160a-n directly in electrical communication with end user equipment, such as routers, telephones, home security systems, and so forth (not shown). As presented herein, ONU's are typically found at a curb and ONT(s) extend to a premise, but both generally behave the same with respect to embodiments of this invention. Data communications 110 may be transmitted to the OLT 115 from a wide area network (WAN) 105. “Data” as used herein refers to voice, video, analog, or digital data.

Communication of downstream data 120 and upstream data 150 transmitted between the OLT 115 and the ONT(s) 135a-n, 160a-n may be performed using standard communications protocols known in the art. For example, downstream data 120 may be broadcast with identification (ID) data to identify intended recipients for transmitting the downstream data 120 from the OLT 115 to the ONT(s) 135a-n. Time division multiple access (TDMA) may be used for transmitting the upstream data 150 from an individual ONT(s) 135a-n, 160a-n back to the OLT 115. Note that the downstream data 120 is power divided by the OSC 125 into downstream data 130 matching the downstream data 120 “above” the OSC 125 but with power reduced proportionally to the number of paths onto which the OSC 125 divides the downstream data 120. It should be understood that the terms downstream data 120, 130 and upstream data 150, 145a-n are optional traffic signals that typically travel via optical communications paths 127, 140, such as optical fibers.

The PON 100 may be deployed for fiber-to-the-premise (FTTP), fiber-to-the-curb (FTTC), fiber-to-the-node (FTTN), and other fiber-to-the-X (FTTX) applications. The optical fiber 127 in the PON 100 may operate at bandwidths such as 155 mega bits per second (Mbps), 622 Mbps, 1.244 giga bits per second (Gbps), and 2.488 Gbps or other bandwidth implementations. The PON 100 may incorporate asynchronous transfer mode (ATM) communications, broadband services such as Ethernet access and video distribution, Ethernet point-to-multipoint topologies, and native communications of data and time division multiplex (TDM) formats or other communications suitable for a PON 100. ONT(s) 135a-n, 160a-n, may receive and provide communications to and from the PON 100 and may be connected to standard telephones (PSTN and cellular), Internet Protocol telephones, Ethernet units, video devices, computer terminals, digital subscriber lines, wireless access, as well as any other conventional customer premise equipment.

The OLT 115 generates, or passes through, downstream communications 120 to an OSC 125. After flowing through the OSC 125, the downstream communications 120 are broadcast as power reduced downstream communications 130 to the ONT(s) 135a-n, where each ONT 135a-n reads data 130 intended for that particular ONT 135a-n. The downstream communications 120 may also be broadcast to, for example, another OSC 155, where the downstream communications 120 are again split and broadcast to additional ONT(s) 160a-n and/or ONUs (not shown).

Data communications 130 may be transmitted to an ONT 135a-n in the form of voice, data, video, and/or telemetry over fiber connection 140. The ONT(s) 135a-n transmit upstream communication signals 145a-n back to the OSC 125 via an optical link, such as fiber connection 140. The OSC 125, in turn, combines the ONT's 135a-n upstream signals 145a-n and transmits a combined signal 150 back to the OLT 115 employing, for example, a time division multiplex (TDM) protocol to determine from which ONT 135a-n portions of the combined signal 150 are received. The OLT 115 may further transmit the communication signals 112 to a WAN 105.

Communications between the OLT 115 and the ONT(s) 135a-n occur using a downstream wavelength, such as 1490 nanometers (nm), and an upstream wavelength, such as 1310 nm. The downstream communications 120 broadcast from the OLT 115 to the ONT(s) 135a-n may be provided at 2.488 Gbps, which is shared across all ONT(s). The upstream communications transmitted 145a-n from the ONT(s) 135a-n to the OLT 115 may be provided at 1.244 Gbps, which is shared among all ONT(s) 135a-n connected to the OSC 125. Other communication data rates known in the art may also be employed.

In an example embodiment of the invention, a method, or corresponding apparatus of identifying a fault in a PON includes transmitting a test series of at least one data pattern via an optical communications path from a first network node to a second network node. The test series may be compared to an expected series of at least one data pattern expected to be observed in the test series transmitted via the optical communications path. The embodiment may include calculating an error rate as a function of differences between the test series and expected series and reporting the error rate to identify a fault in the passive optical network.

An alternative embodiment may include determining a trend of the error rate across a length of the test series and may further include storing an error rate and using the stored error rate to monitor a trend of the error rate over time. The error rate information may also be stored and reported at a later time, such as when network communications are intermittent or temporarily disabled and later enabled.

The embodiment may also include monitoring the error rate for intermittent changes in the error rate, monitoring SNR changes over time, or monitoring increases in error rates over long period of time relative to the test series to detect optical network degradation effects. The embodiment may further include adjusting parameters at the first or second network node to compensate for the degradation effects. For example, long-term monitoring of a PON's error rate may provide baseline operating parameters for the PON. A slow increase in error rate may indicate component aging. In this case, parameters, such as a power output level, may be increased to compensate for the degradation effects.

Another embodiment may include transmitting the test series via separate communications signals or adding the test series to network traffic communications signal and may include transmitting at least 10 kilobits representing the test series. The rate of test series of data patterns may be adjusted to detect different types of faults or the same fault with different accuracies. For example, increasing the rate of test series of data patterns may increase error rate measurement resolution, allowing the identification of high error rates that occur in short periods of time. Different types of errors, such as intermittent, bursty, or degradation may also be determined.

Still another embodiment may include multiple second network nodes and may further include turning off transmitter communications in at least one of the second network nodes and monitoring error rate at a given one of the second network nodes to identify cross communications between the second network nodes.

During a ranging process, another embodiment may include determining whether the error rate exceeds a threshold, terminating the ranging process in an event the error rate exceeds the threshold, and preventing a given second network node from accessing the network in an event the error rate exceeds the threshold.

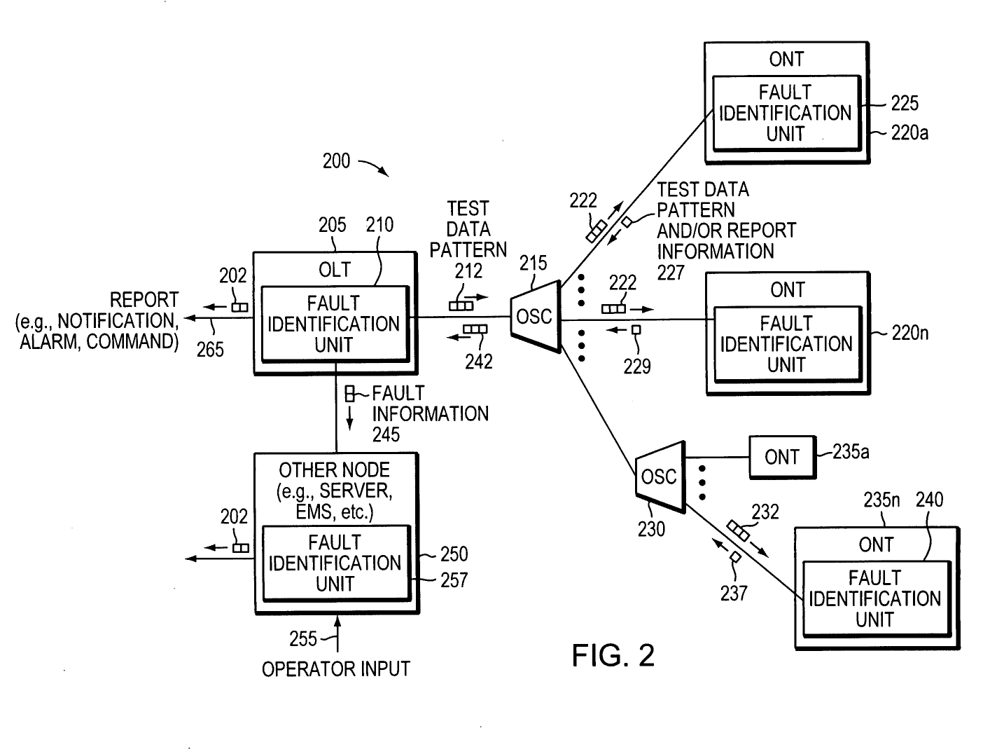

FIG. 2 is a detailed block diagram of a PON 200 employing fault identification units 210, 225, 240 in optical network node components 205, 220a-n, according to an example embodiment of the invention. Communications between an OLT 205, OSC 215, 230, and ONT(s) 220a-n, 235a-n may be conducted in a manner similar to that as described in FIG. 1. Communication signals 202 are transmitted between the OLT 205 and a WAN (not shown). A transmitting optical network node, such as an OLT 205, transmits optical signals 212 to an OSC 215. After splitting and flowing through the OSC 215, the optical signals 222 continue on to a receiving optical network node, such as the ONT 220a. The OLT 205 and/or the ONT 220a may include a fault identification unit 210, 225 configured to identify optical faults in the PON, by measuring performance characteristics such as bit error rate (BER) and low signal-to-noise (SNR). Faults may also be determined by monitoring SNR changes over time.

In one example embodiment, the OLT 205 may initiate the fault identification technique by causing the fault identification unit 210 to generate a test series of at least one data pattern. Alternatively, the test series of at least one data pattern may be read from a storage location. Several bit error rate detection test patterns are known, such as a quasi random signal source bit sequence (QRSS) patterns. The OLT 205 then transmits the series of known test data patterns, for example, QRSS patterns. The test data pattern is communicated to, and split by, the OSC 215, and is then further communicated to the appropriate ONT(s) 220a-n.

The appropriate ONT(s) 220a-n receives the series of test data patterns. The test data patterns may also be known to the ONT(s) 220a-n (e.g., both the OLT 205 and the ONT(s) 220a-n may store the same known test data pattern). The ONT(s) 220a-n may then compare the known test data patterns with an expected series of data patterns to identify error rate information related to the downstream communication signals 222, such as the rate of errors and/or a rate of change in the error rate. The ONT(s) 220a-n may transmit the error rate information upstream (e.g., reported via a management channel) embedded within a communication signal 227, 229, 237. The upstream communication signals 227, 229, 237 are combined at the OSC 215, 230, and the resulting signal 242, including error rate information, is then transmitted back to the OLT 205 via the combined communication signal 242.

Test data patterns may be contained within a standard communications signal, or within a maintenance signal transmitted in a sub-band channel, or the like. The OLT 205 may transmit thousands, or millions, of ATM payloads containing the test data patterns to the ONT(s) 220a-n. In this way, intermittent and bursty errors not detectable using conventional error detection methods, such as that described in ITU G.983.1, are readily observable. Fault identification may occur as part of a system maintenance operation, in response to operator input 255, or operator defined conditions, such as when the error rate exceeds a threshold value.

In addition, or alternatively, the ONT(s) 220a-n may also generate a series of similarly known test data patterns, such as QRSS patterns, and transmit the test data patterns within the upstream communication signals 227, 229, 237. The test data pattern may be embedded within a standard communications signal, or within a maintenance signal transmitted in a sub-band channel, or the like. The upstream communication signals 227, 229, 232, including the test data patterns, are combined at the OSC 215 and further transmitted to the OLT 205. The test data patterns may also be known to the OLT 205.

The OLT 205 may then compare the series of known test data patterns with an expected series of data patterns to identify an error rate of the upstream communication signals 222. In this way, the error rate information of upstream, and/or downstream communications signals may be identified. This error rate information 202 may then be transmitted as, for example, a report or alarm 265 to a system operator, element management system 250, or the like. The OLT 205 may also use the error rate information to attempt to fix the error (e.g., increase laser power).

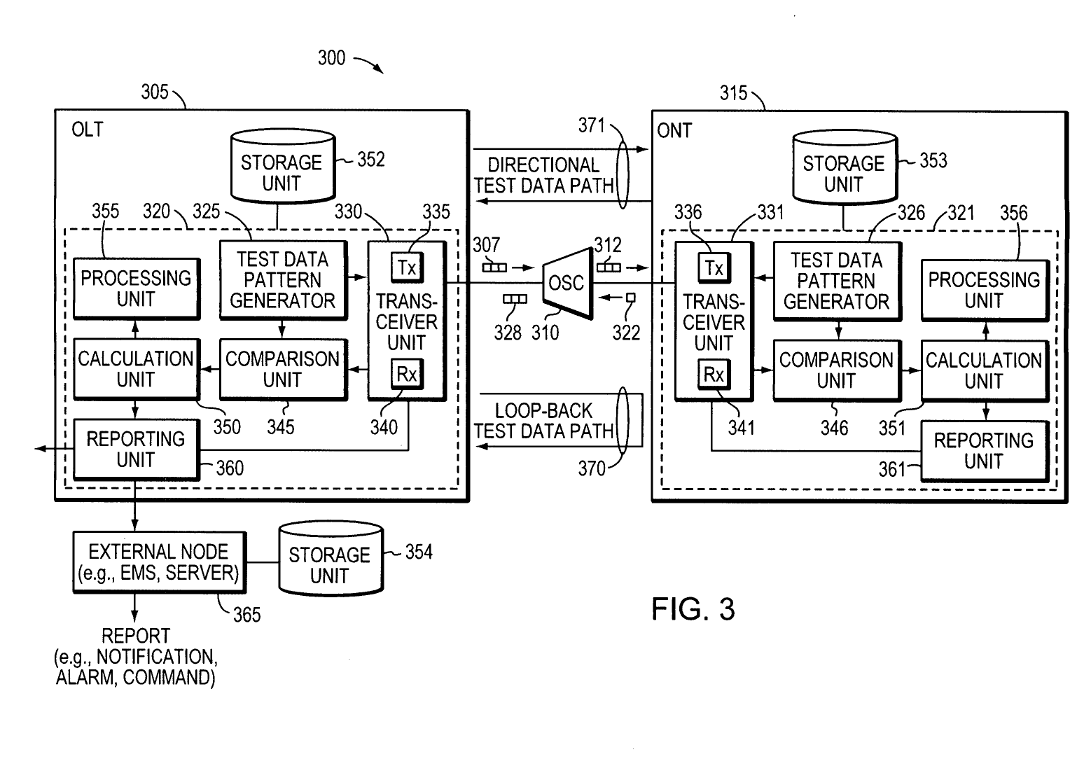

FIG. 3 is a block diagram of a PON 300 illustrating in further detail the fault identification units 210, 225, 257 shown in FIG. 2. In an example embodiment of the present invention illustrated in FIG. 3, an OLT 305 may contain a storage unit 352 and a fault identification unit 320. The fault identification unit 320 may include a test data pattern generator 325, comparison unit 345, transceiver unit 330, calculation unit 350, a reporting unit 360, and processing unit 355.

In operation, according to the example embodiment, a “directional test data path” 371 is used. A series of known test data patterns may be stored in a storage unit 352, such as in non-volatile memory, RAM, or magnetic disk, or alternatively may be communicated to the fault identification unit 320 via an external node 365. The test data pattern generator 325 generates and communicates a series of test data patterns to the transceiver unit 330. The transceiver unit 330 may include a transmitter unit (Tx) 335 and a receiver unit (Rx) 340 internally, externally, or independently. The transmitter 335 transmits the test data patterns via communications signal 307 to the OSC 310 where the signal 307 is split and further flows to at least one ONT 315.

The signal 312 is received by a receiver 341 in the transceiver unit 331 and further communicated to a comparison unit 346. The comparison unit 346 compares the series of test data patterns to a series of expected data patterns expected to be observed in the test series transmitted by the OLT 305. The comparison information is communicated to a calculation unit 351, where BER and SNR values may be calculated. Alternatively, or in addition, calculation results may be determined by a processing unit 356 or may be further processed, for example, tested against a threshold value. Error rate information is communicated to a reporting unit 361 and further communicated to the transceiver unit 331.

A transmitter (Tx) 336 then communicates error rate information embedded within an upstream communications signal 322 to the OSC 310 where the signal may be combined with other ONT signals (not shown) and further communicated to the OLT 305. This information may be indicative of downstream error rate conditions.

In the example embodiment, a similar fault identification technique occurs at the ONT 315 when communicating upstream communications signals 322. A series of known test data patterns may be stored in a storage unit 353, such as in non-volatile memory, RAM, or magnetic disk, or alternatively may be communicated to the fault identification unit 321 from an external node 365 via OLT 305. A test data pattern generator 326 generates and communicates a series of test data patterns to the transceiver unit 331. The transmitter 336 transmits the test data patterns via communications signal 322 to the OSC 310 where the signal 322 is split and further flows upstream to the OLT 305.

The signal 328 is received by a receiver 340 in the transceiver unit 330 and further communicated to a comparison unit 345. The comparison unit 345 compares the series of test data patterns to a series of expected data patterns expected to be observed in the test series transmitted by the ONT 315. The comparison information is communicated to a calculation unit 351 where BER and SNR values may be calculated. Alternatively, or in addition, calculation results may be determined by a processing unit 355 or may be further processed, for example, tested against a threshold value. Error rate information is communicated to a reporting unit 360. Thus, error rate information may help identify which particular fiber link(s) and ONT(s) the errors occur, but also the direction (i.e., downstream and/or upstream) as well.

In an alternative example embodiment, a “loop-back test data path” 370 may be employed. In this embodiment, a series of known test data patterns may be stored in a storage unit 352, such as in non-volatile memory, RAM, or magnetic disk, or alternatively may be communicated to the fault identification unit 320 via an external node 365. The OLT's 305 test data pattern generator 325 generates and communicates a series of test data patterns to the transmitter unit 335 which transmits the test data patterns via communications signal 307 to the OSC 310 where the signal 307 is split and further flows to at least one ONT 315.

The signal 312 is received by the ONT's 315 receiver unit 341. However, with the loop back technique, rather than identifying the error rate at the ONT 315, the test data pattern is simply ‘looped back’ and transmitted back to the OLT 305. The test data pattern may be embedded within a communications signal 322, and the transmitter 336 communicates the signal 322 upstream to the OLT 305.

The signal 328 is received by the receiver 340 and further communicated to the comparison unit 345. The comparison unit 345 compares the series of test data patterns to a series of expected data patterns expected to be observed in the test series as transmitted by the OLT 305. The comparison information is communicated to the calculation unit 350, where BER and SNR values may be calculated. Alternatively, or in addition, calculation results may be determined and/or further processed by the processing unit 355. Error rate information may be communicated to a reporting unit 360 to generate, for example, a report or alarm.

The “loop-back” technique described above and shown in FIG. 3 may be useful for ONT(s) 315 that lack the appropriate comparison unit 346, calculation unit 351, or processing unit 356 necessary to identify directionality of the error rates. While the loop back data path 370 may not identify directional rate information (i.e., upstream v. downstream) to the same degree as techniques employing the directional test data path 371, valuable information is still provided in that it identifies on which fiber link(s) and/or ONT(s) the error rate is observed. Furthermore, if the ONT(s) 315 is made aware of the location of the downstream signal's 312 checksum, the ONT(s) 315 may calculate a downstream error rate and then report the downstream error rate, in addition to the data being looped back, upstream to the OLT 305.

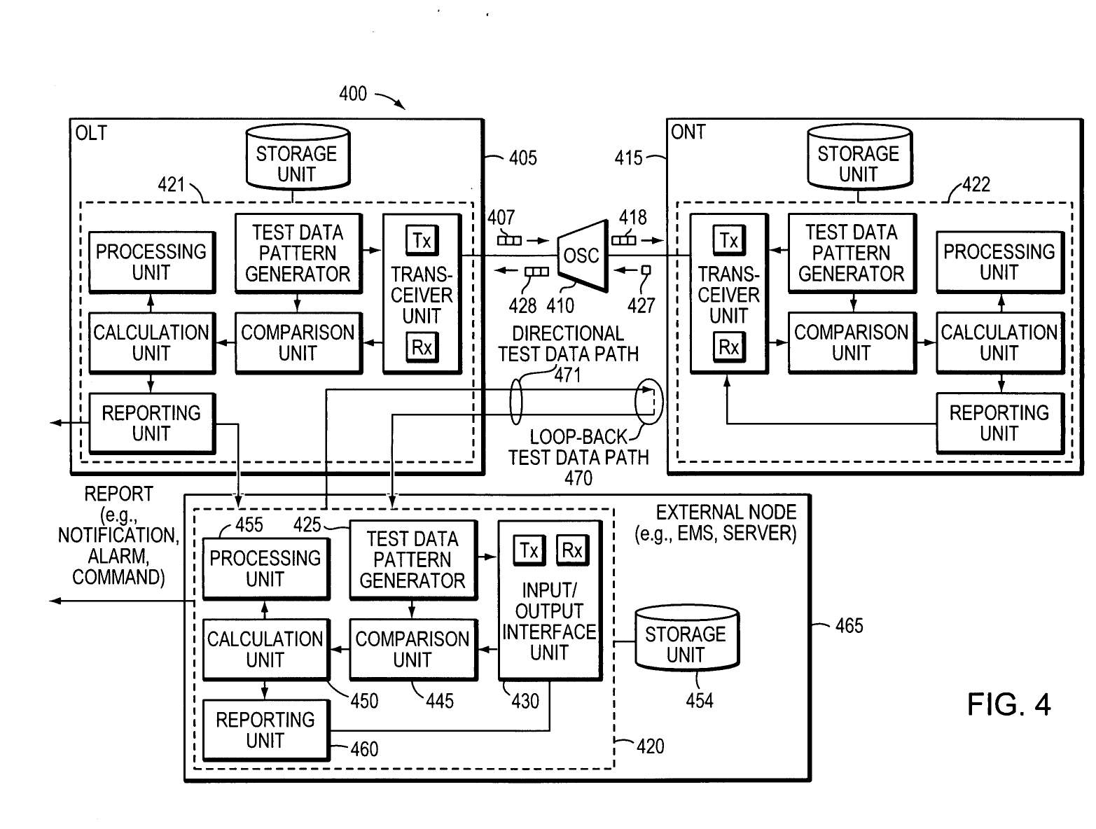

FIG. 4 is a network block diagram 400 of example embodiments in which an external node 465, such as a server or element management system (EMS), is configured to identify faults in a PON. In one embodiment, using a “loop-back test data path” 470, the test data pattern 407 is generated by the external node 465, communicated to an ONT 415, and is then looped back to the external node 465. In an alternative embodiment, using a “directional test data path” 471, the downstream test data pattern 407 is similarly generated by the external node 465 and the upstream test data pattern is generated by the ONT(s) 415. The directional path and loop-back path techniques are conceptually similar to that as described in reference to FIG. 3 with the addition of the external node.

The external node 465 may contain a fault identification unit 420 and a storage unit 454, such as in non-volatile memory, RAM, or magnetic disk. The fault identification unit 420 may contain a test data pattern generator 425, comparison unit 445, input/output (I/O) interface unit 430, calculation unit 450, reporting unit 460, and processing unit 455.

In one embodiment, the directional path technique may be used. A series of known test data patterns may be stored in the storage unit 454, or alternatively communicated to the fault identification unit 420 from an external source, such as a WAN (not shown). The test data pattern generator 425 generates a series of known test data patterns which are communicated to the I/O interface unit 430 which, in turn, transmits the test data patterns to the OLT 405. The OLT 405 transmits the test data pattern, embedded in a downstream signal 407, to the OSC 410 where the signal 407 is split and further flows to at least one ONT 415.

The downstream signal 418 is received by the fault identification unit 422, where the series of test data patterns are compared to a known series of expected data patterns expected to be observed in the test series transmitted by the external node 465 via the OLT 405. The fault identification unit 422 may then calculate downstream error rate information, such as BER and SNR and communicate the information, embedded in an upstream signal 427, back to the OLT 405 where it may be further communicated to the external node 465. Alternatively, the received test data patterns may be communicated back to the external node 465 via the OLT 405 where downstream error rate information, such as BER and SNR values may be calculated therein.

A similar fault identification technique may be employed at the ONT(s) 415 when communicating upstream signals 427. The fault identification unit 422 generates a series of known test data patterns which may be embedded in an upstream signal 427 and communicated back to the OLT 405 and further communicated to the external node 465.

The signal is received by the I/O interface unit 430 and further communicated to the comparison unit 445. The comparison unit 445 compares the series of test data patterns to a series of expected data patterns expected to be observed in the test series transmitted by the ONT(s) 415. The comparison information is communicated to the calculation unit 450 where fault information, such as BER and SNR values may be calculated. Alternatively, or in addition, calculation results may be performed by the processing unit 455 or may be further processed, for example, tested against a user provided threshold value. Error rate information is communicated to a reporting unit 460.

In this way, an external node using the directional test data path technique may provide error rate information useful in identifying not only which particular fiber link(s) and ONT(s) errors occur, but also the direction (i.e., downstream and/or upstream).

In an alternative embodiment “the loop-back data path” 470 may be used. Continuing to refer FIG. 4, a series of known test data patterns may be stored in the storage unit 454, or may be communicated to the external node 465 from, for example, a WAN (not shown). The external node's 465 test data pattern generator 425 generates and communicates a known series of test data patterns to the I/O interface unit 430 which, in turn, transmits the test data patterns to the OLT 405. The OLT 405 then transmits the test data patterns, embedded in signal 407, to the ONT 415.

The signal 418 is received and processed by the intended ONT(s) 415. The test data pattern is then ‘looped back’ by retransmitting the received test data pattern back to the OLT 405. The test data pattern is embedded in the upstream signal 427 and is communicated back to the OLT 405, and further communicated to the external node 465.

The signal is received by the I/O interface unit 430 and further communicated to the comparison unit 445. The comparison unit 445 compares the series of test data patterns to a known series of expected of data patterns expected to be observed in the test series as transmitted by the external node 465. The comparison information is communicated to the calculation unit 450 where error rate information, such as BER and SNR values may be calculated. Alternatively, or in addition, calculation results may be calculated and/or further processed by a processing unit 455. The error rate information may be used to identify faulty fiber link(s) and/or ONT(s). Error rate information may also be communicated to a reporting unit 460 to generate, for example, a report or alarm.

In an alternative embodiment, the ONT(s) 415 is made aware (e.g., via information in the downstream signal 418) of the location of the downstream signal's 418 checksum. The ONT(s) 415 may then calculate a downstream error rate and report the downstream error rate, in addition to the data being looped back, upstream to the OLT 405 and the external node 465.

The external node embodiments described above with reference to FIG. 4 consume little or no memory in the OLT 405 and ONT 415, and effectively off-load fault identification processing to an external node 465, while still providing valuable information with regard to faults observed on a particular fiber link(s) and/or ONT(s).

The block diagrams of FIGS. 3 and 4 are merely representative and that more or fewer units may be used, and operations may not necessary be divided up as described herein. Also, a processor executing software may operate to execute operations performed by the units, where the dashed lines (e.g., dashed lines 420, 421) may represent a processor. It should be understood that the block diagrams may, in practice, be implemented in hardware, firmware, or software. If implemented in software, the software may be any form capable of performing operations described herein, stored on any form of computer readable-medium, such as RAM, ROM, CD-ROM, and loaded and executed by a general purpose or application specific processor capable of performing operations described herein.

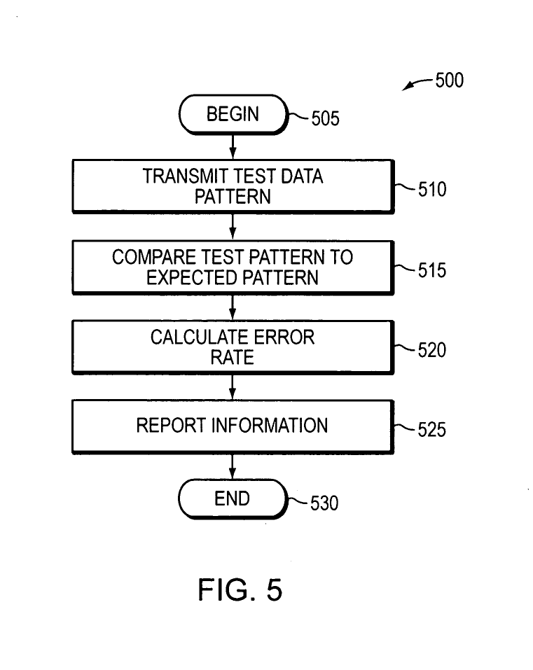

FIG. 5 illustrates, in the form of a flow diagram, an exemplary embodiment of the present invention. It should, however, be evident that various modifications and changes may be made thereto without departing from the broader spirit and scope of the present invention. For example, some of the illustrated flow diagrams may be performed in an order other than that which is described. It should be appreciated that not all of the illustrated flow diagrams is required to be performed, that additional flow diagram(s) may be added, and that some may be substituted with other flow diagram(s).

The embodiment of FIG. 5 is depicts a process 500 illustrating an example embodiment of the invention. The process 500 begins (505) and may transmit a test series of data patterns (510) from a first network node, such as an OLT, to a second network, such as an ONT, in a PON. The test series of data patterns may be compared to an expected series of data patterns (515) expected to be observed in the test series transmitted via an optical network path. An error rate may be calculated as a function of differences between the test series and the expected series (520). The error rate identifying a fault in the PON may be reported (525), and the process ends (530).

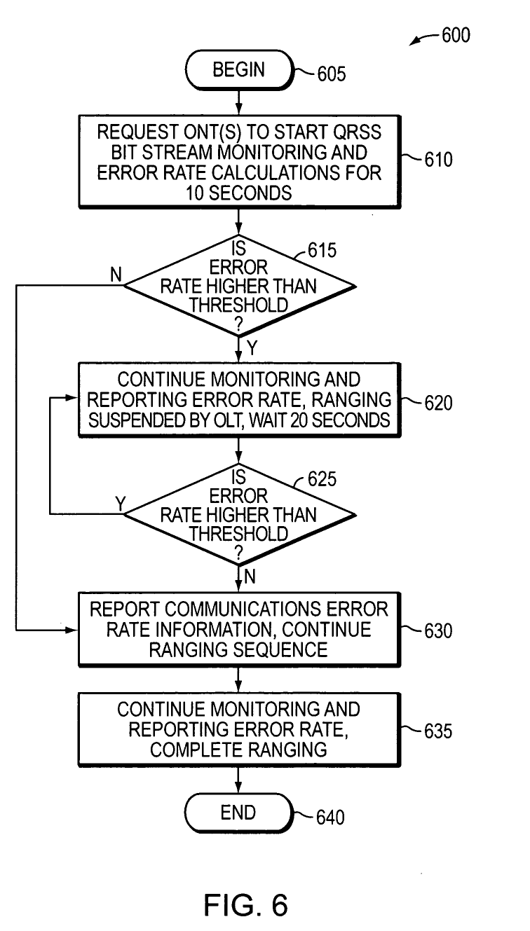

FIG. 6 is a flow diagram of a process 600 illustrating an example embodiment of the invention. The process 600 begins (605) and may request ONT(s) to start QRSS bit stream monitoring and error rate calculations for a given length of time, such as 10 seconds (610), which may be predetermined or dynamically determined during the monitoring. If the error rate is higher than a threshold (615), the process 600 continues to monitor and report error rate information, suspends ranging by the OLT, and waits, such as for 20 seconds (620), and then checks to see if the error rate is still higher than the threshold (625). If the error rate is higher than the threshold, the process again continues to monitor and report error rate information, suspends ranging by the OLT, and waits, for example, 20 seconds (620). If the error rate is not higher that the threshold (615, 625), the process 600 reports communications error rate information, continues the ranging sequence (630), and then ends (640).

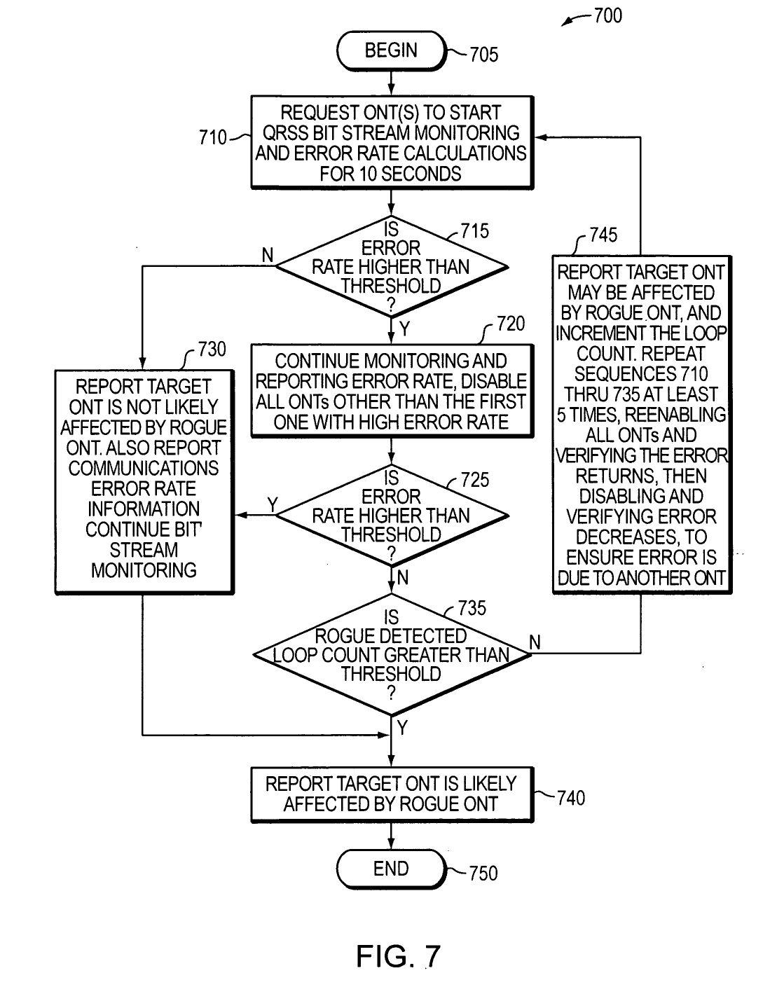

FIG. 7 is a flow diagram of a process 700 illustrating an example embodiment of the invention. The process 700 begins (705) and may request ONT(s) to start QRSS bit stream monitoring and error rate calculations for 10 seconds (710), for example. If the error rate is not higher than a threshold (715), the process 700 reports that the target ONT is not likely affected by a rogue ONT, reports communications error rate information, continues bit stream monitoring (730), and then ends (750). If the error rate is higher than a threshold (715), the process 700 continues to monitor and report error rate information, and disables all ONT(s) other than the first one with a high error rate (720).

The error rate is again checked to see if it is higher than the threshold (725), and, if so, the process 700 reports that the target ONT is not likely affected by a rogue ONT, reports communications error rate information, continues bit stream monitoring (730), and then ends (750).

If the error rate is not higher than the threshold (725), the process 700 checks to see if a rogue detected loop count is greater than a threshold (735). If not, the process 700 reports that the target ONT may be affected by the rogue ONT, and the rogue detected loop count is incremented. The process continues by repeating sequences 710 through 735 at least five times, re-enabling all ONT(s) and verifying the error returns, then disabling and verifying that the error decreases to ensure the error is due to a different ONT (745). If the rogue detected loop count is greater than a threshold (735), the process 700 reports that the target ONT is likely affected by the rogue ONT (740), and then the process 700 ends (750).

It should be readily appreciated by those of ordinary skill in the art that the aforementioned steps are merely exemplary and that the present invention is in no way limited to the number of steps or the ordering of steps described above.

Some or all of the steps may be implemented in hardware, firmware, or software. If implemented in software, the software may be (i) stored locally with the OLT, the ONT, or some other remote location such as the EMS, or (ii) stored remotely and downloaded to the OLT, the ONT, or the EMS during, for example, the begin sequence. The software may also be updated locally or remotely. To begin operations in a software implementation, the OLT, the ONT, or EMS loads and executes the software in any manner known in the art.

While this invention has been particularly shown and described with references to example embodiments thereof, it will be understood by those skilled in the art that various changes in form and details may be made therein without departing from the scope of the invention encompassed by the appended claims.

1. A method of identifying a fault in a passive optical network (PON), comprising:
transmitting a test series of at least one data pattern via an optical communications path from a first network node to a second network node in a passive optical network;
comparing the test series to an expected series of at least one data pattern expected to be observed in the test series transmitted via the optical communications path;
calculating an error rate as a function of differences between the test series and expected series; and
reporting the error rate to identify a fault in the passive optical network.

2. The method according to claim 1 further including determining a trend of the error rate across a length of the test series.

3. The method according to claim 1 further including storing an error rate and using the stored error rate to monitor a trend of the error rate over time.

4. The method according to claim 1 further including monitoring the error rate for intermittent changes in the error rate.

5. The method according to claim 1, wherein transmitting the test series of data patterns includes transmitting at least 10 kilobits representing the test series.

6. The method according to claim 1, wherein the test series of the at least one data pattern is known.

7. The method according to claim 6, wherein the test series of at least one data pattern is a Quasi Random Signal Source (QRSS) data pattern.

8. The method according to claim 1 further including generating the test series of at least one data pattern or reading the test series of at least one data pattern from a storage location.

9. The method according to claim 1, wherein the comparing occurs at the second network node or a third network node.

10. The method according to claim 1 further including looping back the test series transmitted via the optical communications path and wherein the comparing occurs at the first network node or a third network node.

11. The method according to claim 1 further including:
multiple second network nodes;
turning off transmitter communications in at least one of the second network nodes; and
monitoring error rate at a given one of the second network nodes to identify cross communications between the second network nodes.

12. The method according to claim 1 further including monitoring increases in error rates over a long period of time relative to the test series to detect optical network degradation effects.

13. The method according to claim 12 further including adjusting parameters at the first or second network node to compensate for the degradation effects.

14. The method according to claim 1 further including determining faults by monitoring signal-to-noise ratio changes over time.

15. The method according to claim 1, wherein transmitting the test series of data patterns includes transmitting the test series via separate communications signals or adding the test series to network traffic communications signals.

16. The method according to claim 1 further including using the method during a ranging process, determining whether the error rate exceeds a threshold, terminating the ranging process in an event the error rate exceeds the threshold, and preventing a given second network node from accessing the network in an event the error rate exceeds the threshold.

17. The method according to claim 1 further including adjusting a rate of test series data patterns to detect different types of faults or the same fault with different accuracies.

18. An apparatus for identifying faults in a passive optical network (PON), comprising:
a transmitting unit configured to transmit a test series of at least one data pattern via an optical communications path from a first network node to a second network node in a passive optical network;
a comparison unit configured to compare the test series to an expected series of at least one data pattern expected to be observed in the test series transmitted via the optical communications path;
a calculation unit configured to calculate an error rate as a function of differences between the test series and expected series; and
a reporting unit configured to report the error rate to identify a fault in the passive optical network.

19. The apparatus according to claim 18 wherein the calculation unit is configured to determine a trend of the error rate across a length of the test series.

20. The apparatus according to claim 18 further including a storage unit configured to store an error rate and using the stored error rate to monitor a trend of the error rate over time.

21. The apparatus according to claim 18, wherein the calculation unit is configured to monitor the error rate for intermittent changes in the error rate.

22. The apparatus according to claim 18, wherein transmitting the test series of data patterns includes transmitting at least 10 kilobits representing the test series.

23. The apparatus according to claim 18, wherein the test series of the at least one data pattern is known.

24. The apparatus according to claim 23, wherein the test series of at least one data pattern is a Quasi Random Signal Source (QRSS) data pattern.

25. The apparatus according to claim 18 the transmitting unit is configured to generate the test series of at least one data pattern or read the test series of the at least one data pattern from a storage location.

26. The apparatus according to claim 18, wherein the comparison unit is configured to compare at the second network node or a third network node.

27. The apparatus according to claim 18 further including configuring the apparatus to loop back the test series transmitted via the optical communications path and wherein the comparison unit is configured to compare at the first network node or a third network node.

28. The apparatus according to claim 18 further including:
multiple second network nodes;
a processing unit configured to turn off transmitter communications in at least one of the second network nodes; and
wherein a given one of the second network nodes is configured to monitor error rate to identify cross communications between the second network nodes.

29. The apparatus according to claim 18, wherein the reporting unit is configured to monitor increases in error rates over a long period of time relative to the test series to detect optical network degradation effects.

30. The apparatus according to claim 29, wherein the first or second network node is configured to adjust parameters to compensate for the degradation effects.

31. The apparatus according to claim 18, wherein the calculation unit is configured to determine faults by monitoring signal-to-noise ratio changes over time.

32. The apparatus according to claim 18, wherein the transmitting unit is further configured to transmit the test series via separate communications signals or adding the test series to network traffic communication signals.

33. The apparatus according to claim 18 further including a processing unit configured to, during a ranging process, determine whether the error rate exceeds a threshold, terminate the ranging process in an event the error rate exceeds the threshold, and prevent a given second network node from accessing the network in an event the error rate exceeds the threshold.

34. The apparatus according to claim 18 wherein the transmitting unit is further configured to adjust a rate of test series data patterns to detect different types of faults or the same fault with different accuracies.

35. A computer program product for identifying a fault in a passive optical network (PON), the computer program product comprising a computer readable medium having computer readable instructions stored thereon, which, when loaded and executed by a processor, causes the processor to:
transmit a test series of at least one data pattern via an optical communications path from a first network node to a second network node in a passive optical network;
compare the test series to an expected series of at least one data pattern expected to be observed in the test series transmitted via the optical communications path;
calculate an error rate as a function of differences between the test series and expected series; and
report the error rate to identify a fault in the passive optical network.
